(19) United States
(12) Patent Application Publication
(10) Pub. No.: US 2017/0137669 A1
(43) Pub. Date: May 18, 2017

(54) SECURITY TAG APPLICATION TO PRODUCT PACKAGING

(71) Applicant: CHECKPOINT SYSTEMS, INC., Thorofare, NJ (US)

(72) Inventors: George West, Aston, PA (US); Seth Strauser, Mullica Hill, NJ (US); Takeshi Matsumoto, Kouza-gun (JP); Kousaku Yoshimura, Chigasaki-City (JP)

(21) Appl. No.: 14/944,694

(22) Filed: Nov. 18, 2015

(51) Int. Cl. C09J 5/00; G09F 3/00; G09F 3/10

(52) U.S. Cl. CPC C09J 5/00; G09F 3/10; G09F 3/0297; G09F 2003/0257

(57) ABSTRACT

In one embodiment, the invention can be a method for applying a security tag, the method including a cutting a portion of a top layer of a product packaging, the cutting comprising making cuts that form a closed shape, the cutting causing a break in the top layer that exposes a second layer of the product packaging; and adhering, via an adhesive, a security tag over the cut portion, the adhesive penetrating into the break in the top layer to contact the exposed second layer; wherein, upon removal of the security tag from the product packaging, a section of the cut portion of the top layer is removed from the product packaging.

### BACKGROUND

Protecting retail items from theft is an ongoing concern. There are security tags that can be applied to retail items via an adhesive or other means of attachment for securing retail items. A typical electronic article surveillance (EAS) system will include pedestals that will alarm when a security tag passes through the pedestals. To overcome EAS systems, thieves have different devices for removing the tag. The tag may be removed by the thief in store, or outside of the store.

A large portion of stolen retail items are sold to illicit organizations, which subsequently re-sell the stolen retail items. Typically, the organization purchasing the stolen retail items will pay only a fraction of the intended price of the merchandise. Depending on the quality of the product, and/or the condition of the product's packaging, the purchase price for the stolen retail item may be reduced further.

Since the quality of the product packaging can affect the purchase price, thieves desire to avoid damaging the product packaging when removing security tags. There exists a need to provide a security tag and product packaging whereby removal of the tag causes damage to the product packaging, thus reducing the re-sale value of stolen merchandise and deterring thieves from committing retail theft.

### BRIEF SUMMARY

The present disclosure is directed to a method and system for applying a security tag. In one aspect, the method includes cutting a portion of a top layer of a product packaging, the cutting comprising making cuts that form a closed shape, the cutting causing a break in the top layer that exposes a second layer of the product packaging; and adhering, via an adhesive, a security tag over the cut portion, the adhesive penetrating into the break in the top layer to contact the exposed second layer; wherein, upon removal of the security tag from the product packaging, a section of the cut portion of the top layer is removed from the product packaging.

In another aspect, a method includes degrading a portion of a top layer of the product packaging; and adhering a security tag over the degraded portion.

In yet another aspect, a system includes a degrading tool configured to degrade a portion of a top layer of the product packaging; and a tag applicator configured to adhere a security tag over the degraded portion.

Further areas of applicability of the present method and system will become apparent from the detailed description provided hereinafter. It should be understood that the detailed description and specific examples, while indicating certain embodiments, are intended for purposes of illustration only and are not intended to limit the scope of the invention.

### BRIEF DESCRIPTION OF THE DRAWINGS

The example embodiments of the present disclosure will become more fully understood from the detailed description and the accompanying drawings, wherein:

FIG. 1 is a product packaging and security tag according to one embodiment of the present invention.

FIG. 2 is product packaging having various example cut patterns.

FIG. 3 is a cross-section view of the product packaging and security tag of FIG. 1 before the security tag is applied.

FIG. 4 is a cross-section view of the product packaging and security tag of FIG. 1 after the security tag has been applied.

FIG. 5 is a cross-section view of the product packaging and security tag of FIG. 1 after the security tag is removed.

FIG. 6 is a product packaging and security tag according to another embodiment, where the security tag is placed over a barcode.

FIG. 7 is a system for applying a security tag to a product packaging according to another embodiment.

### DETAILED DESCRIPTION

The following description of the preferred embodiment(s) is merely exemplary in nature and is in no way intended to limit the invention. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” “secured” and similar refer to a relationship wherein structures are secured or attached to one another either directly or indirectly through intervening structures, as well as both movable or rigid attachments or relationships, unless expressly described otherwise. The discussion herein describes and illustrates some possible non-limiting combinations of features that may exist alone or in other combinations of features.

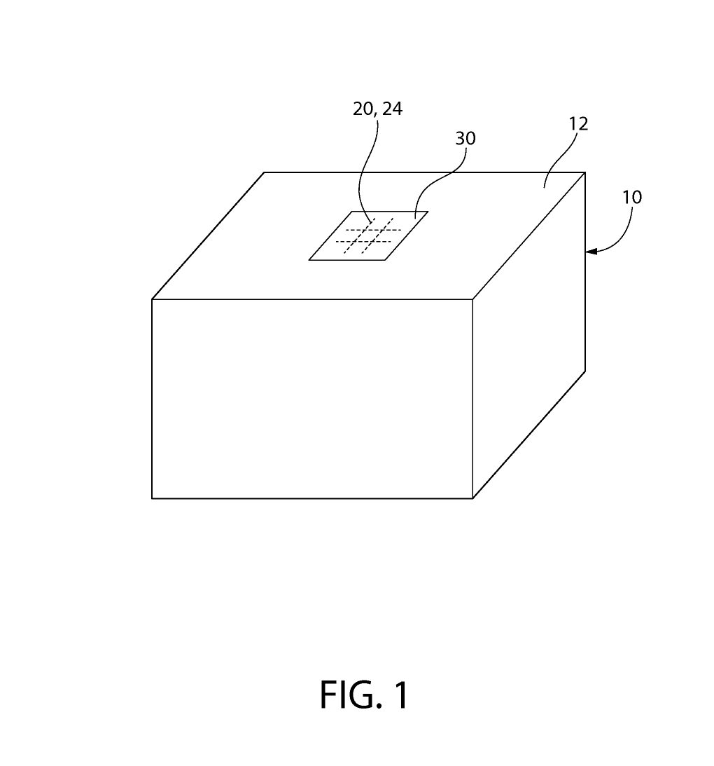

Referring now to FIG. 1, a product packaging 10 and security tag 30 according to one embodiment is shown. In this embodiment, the packaging 10 is a standard cardboard box-shaped packaging 10, and its top layer 12 includes ultraviolet (UV)-coated silicon. In other embodiments, the packaging can be any type of packaging for enclosing a product and receiving a tag. Further, the top layer 12 can include a polyethylene terephthalate (PET) film or another suitable material. Further, the tag can be any type of tag for adhering to a product package to enhance security, including, but not limited to, EAS tags (soft tags or hard tags), non-EAS tags, tags with security warnings, labels, price tags, and tags with other sale or company information.

A challenge with packages having a silicon or similar coating is that it is generally easy to peel adhered tags off such a coating, thus enabling a thief to remove a security tag without damaging the product 50. To address this issue and help ensure that the product packaging 10 is damaged when the security tag 30 is removed, a portion 20 of a top layer 12 of the product packaging 10 is degraded prior to application of the tag 30. In the exemplified embodiment, the top layer 12 is degraded by applying cuts, (e.g., die cuts that are microscopically thin) in the top layer 12 of the product packaging 10. Specifically, the exemplary cuts are intersecting vertical and horizontal lines 24.

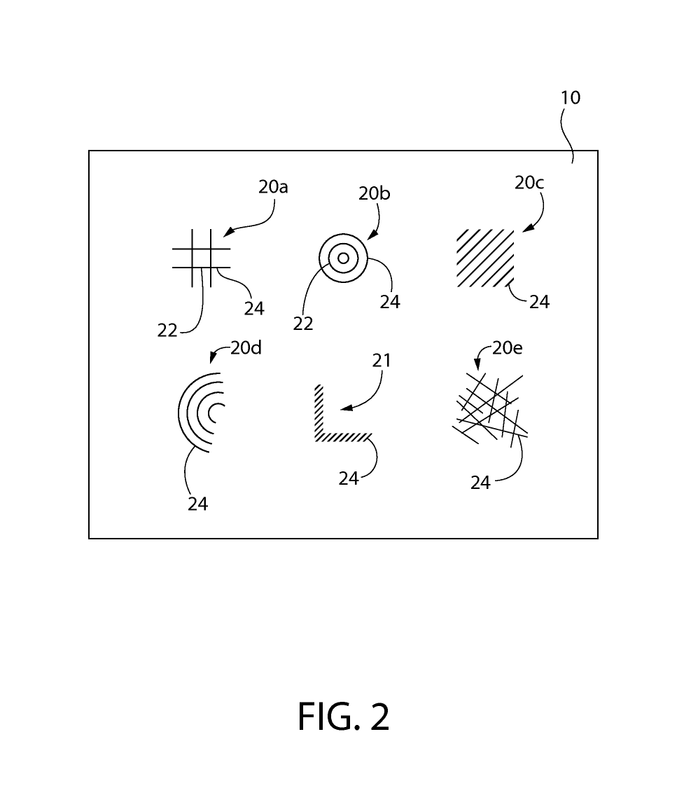

The example embodiments are not limited to any particular cutting pattern, and can include any pattern for degrading the top layer, including patterns made by skiving or scoring. FIG. 2 shows example cutting patterns. Pattern 20a has intersecting vertical and horizontal cut lines 24 similar to that shown in FIG. 1. Pattern 20b has cut lines 24 that form concentric circles. Pattern 20c has diagonal cut lines 24. Pattern 20d has adjacent C-shaped cut lines 24. Pattern 20e has cut lines 24 of random length and orientation.

Patterns 20a and 20b include a cut line or cut lines 24 that form one or more closed shapes 22. The cut lines 24 of pattern 20a from a closed square 22. Further, the cut lines 24 of pattern 20b form three closed circles 22. Such closed shapes 22 can cause a portion of the product packaging defined by the closed shape 22 to more easily pull away when the tag 30 is later removed.

Pattern 21 is in the shape of an “L” and is representative of a logo. The pattern can be any identification pattern, including a name, logo, or image. For example, the pattern can spell the name of the retailer or manufacturer selling the item.

The example embodiments are not limited to degrading by die cutting or other cutting methods, but can include any method of degrading the top layer of a product packaging. For example, the top layer can be degraded by application of a chemical, or by the application of heat (including burning or scorching), or by plasma discharge (e.g., corona treatment). These techniques may nonetheless be utilized to form a closed shape for the degraded area as described above.

Returning to FIG. 1, after the top layer 12 is degraded, the tag 30 can be adhered over the degraded portion 20. In the exemplified embodiment, the tag 30 is centered over the degraded portion 20 and covers the entirety of the degraded portion 20. Covering the entirety of the degraded portion 20 with the tag 30 helps ensure that paying customers do not detect any degrading of the packaging 10. In other embodiments, the tag can overlay only a portion of the degraded portion.

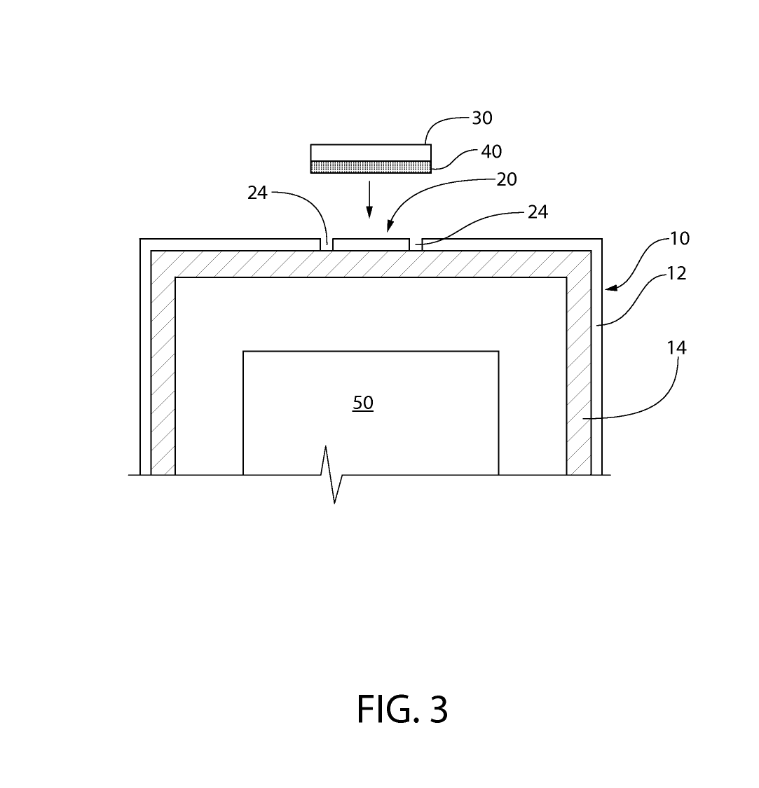

Referring now to FIGS. 3-5, a method for applying and removing a security tag 30 is shown. FIG. 3 shows a cross-section of the product packaging 10 and security tag 30 of FIG. 1 before the security tag 30 is applied. The product packaging 10 includes a top layer 12 and a second layer 14 below the top layer 12, both layers 12, 14 enclosing a product 50. The cutting of the degraded portion 20 causes a break 24 in the top layer 12 that exposes the second layer 14 of the product packaging 10. In this embodiment, the cutting of the degraded portion 20 of the top layer 12 does not cause a break in the exposed second layer 14. Not breaking the exposed second layer 14 can provide stronger adhesion to the second layer 14. In the exemplified embodiment, tag 30 includes an adhesive 40 for the adhering of the security tag 30 over the degraded portion 20. In other embodiments, the operation of adhering the security tag over the degraded portion can include applying an adhesive separate from the security tag to the degraded portion and, subsequently, applying the tag to the adhesive.

The example embodiments are not limited to the above embodiment. In other embodiments, the product packaging 10 can include different numbers of layers. Further, the degrading can be such that it does not cause a break in the top layer. Further, the break 24 can be caused by a non-cutting method of degrading, such as the chemical or heat methods discussed above. Further, the cutting of the degraded portion 20 of the top layer can cause a break in the exposed second layer 14.

The adhesive 40 can be of any type of bonding material, and can be applied at any temperature. In a preferred embodiment, the adhesive 40 has a viscosity of approximately 12000 cPs, and has a high level of oil to provide high initial tack and better penetration of the degraded portions 20 of the top layer 12. An adhesive with a high level of oil can migrate more easily and quickly than harder adhesives. The adhesive can be applied at any temperature. In a preferred embodiment, an adhesive of 11700 cPs is applied at 160° C. In certain other embodiments, the viscosity is 10000-13000 cPs and is applied at a temperature of 150-170° C.

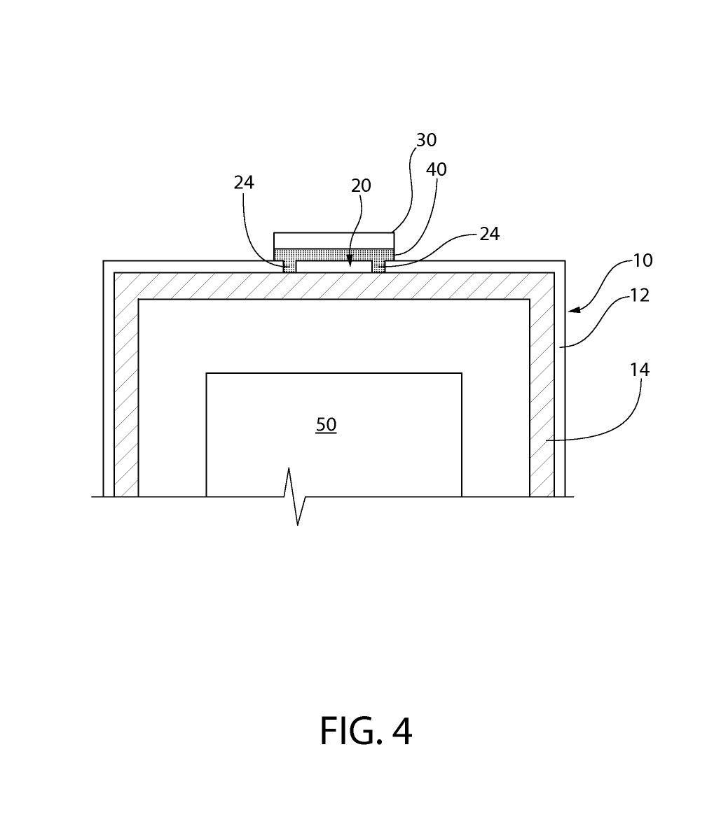

FIG. 4 shows the product packaging 10 once the tag 30 is adhered over the degraded portion 20. The adhesive 40 can penetrate or seep into the breaks 24 in the top layer 12 to contact the exposed second layer 14. In some embodiments, the adhesive 40 can reach a fiber level of the exposed second layer 14 to provide additional bonding. It can be helpful, however, that the adhesive 40 not penetrate too far, to avoid undermining the integrity of the product packaging 10. In other embodiments, the adhesive 40 may not reach a fiber level, or not contact a second layer at all.

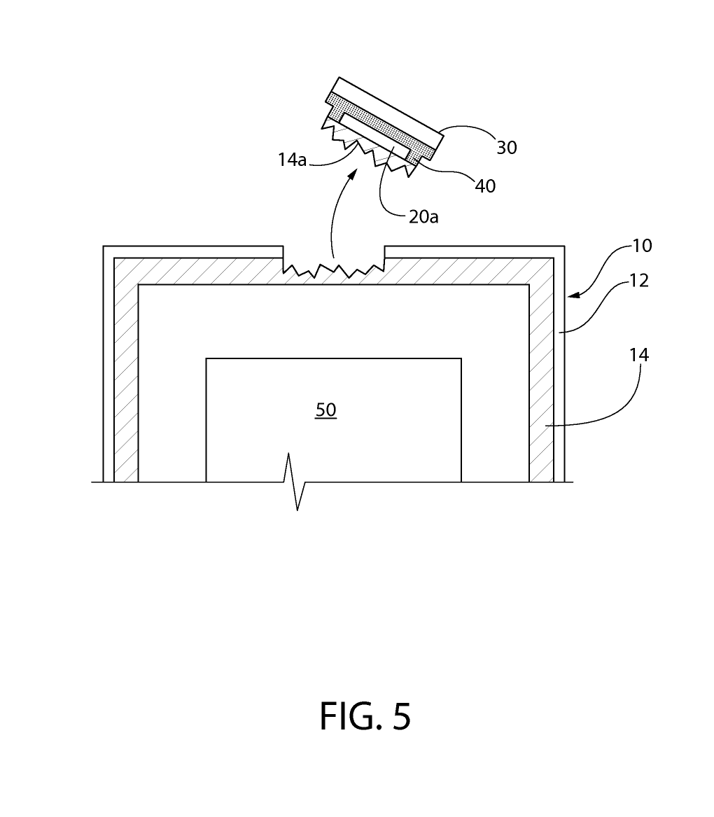

FIG. 5 shows the product packaging 10 once the tag 30 is removed. Upon removal of the tag 30 from the packaging 10, a section 20a of the degraded (cut) portion 20 of the top layer 12 is removed from the product packaging 10. Further, a section 14a of the second layer 14 is removed from the product packaging 10. These removed sections 20a, 14a will result in visible damage to the product packaging 10, thereby compromising the re-sale value of the product. The removal of the degraded top layer section 20a can provide visible evidence of damage to the product packaging 10, and the removal of the second layer section 14a can provide easily visible evidence of such damage. In the exemplified embodiment, removal of the degraded top layer section 20a will result in the removal of UV-coated silicon while removal of the second layer section 14a will remove a portion of the printing on the cardboard of the product packaging 10. In other embodiments, only one layer section can be removed from the product packaging.

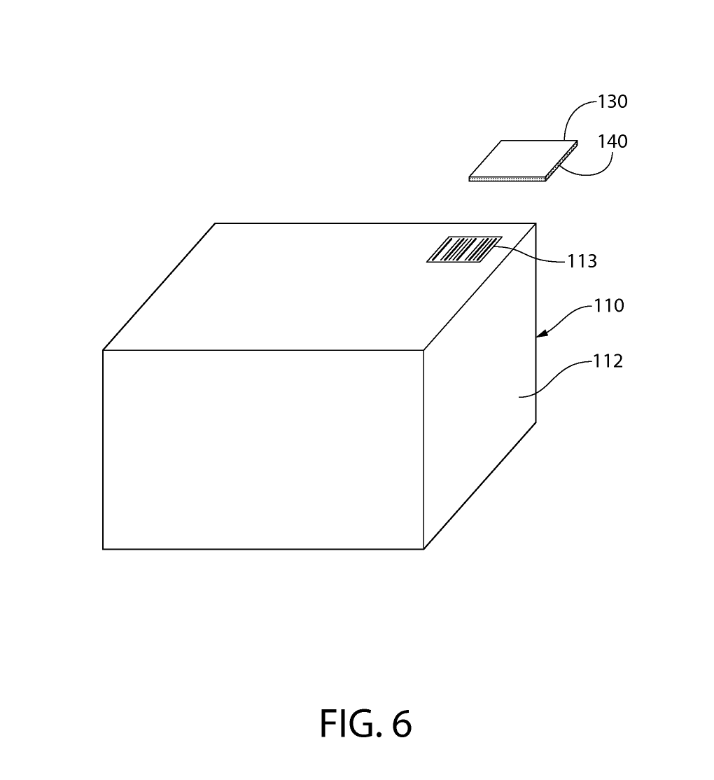

FIG. 6 shows a product packaging 110 and security tag 130 according to another embodiment, where the security tag 130 is placed over a barcode 113. This embodiment is similar to the embodiment described with respect to FIGS. 1-5, except that the top layer 112 has a portion that comprises a barcode 113. Similar to the earlier embodiment, the barcode portion 113 of the top layer 112 is degraded. A security tag 130 can then be adhered, via an adhesive 140, to the degraded portion (not shown) of the barcode 113. The adhesive 140 can penetrate a break in the barcode portion 113 to contact a second layer (not shown). Upon removal of the security tag 130, a section of the barcode portion 113 can be removed from the product packaging 110, thereby rendering the barcode inoperable. By placing the tag 130 over a barcode 113 and enabling destruction of the barcode 113, one can provide additional theft deterrence. If a thief removes a portion of the barcode 113 when removing the security tag 130, the barcode 113 will be unusable, which will significantly compromise the value of the packaged retail item. To enable the barcode 113 to function when a security tag 130 is placed over it, the security tag 130 can include a portion that is transparent. The alternative features discussed above with respect to FIGS. 1-5 can also apply generally to the embodiment shown in FIG. 6.

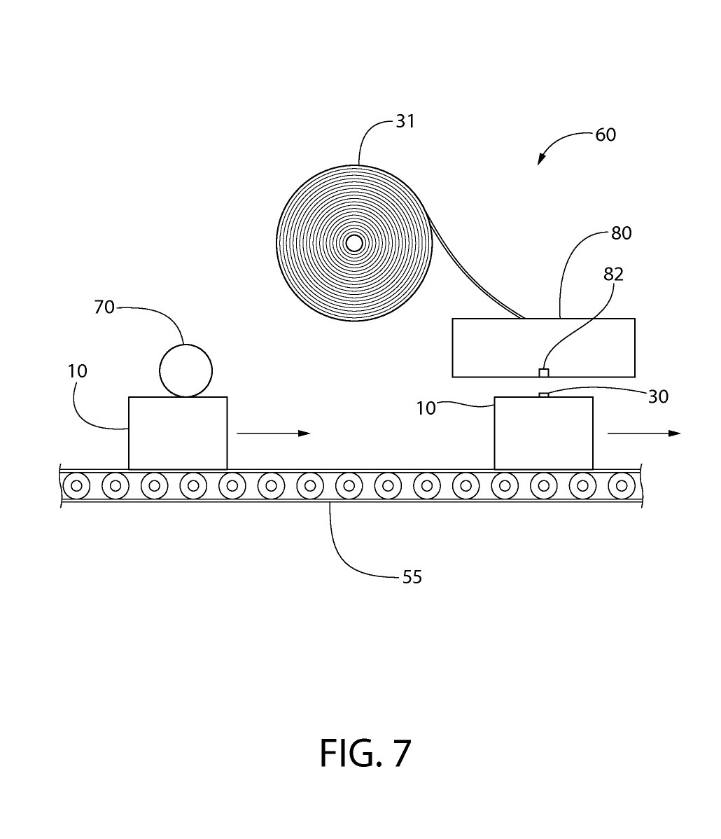

FIG. 7 shows a system 60 for applying a security tag 30 to a product packaging 10 according to another embodiment. The system 60 includes a degrading tool 70 configured to degrade a portion of a top layer 12 of the product packaging 10. In the exemplified embodiment, the degrading tool 70 is a die-cutting tool for making cut lines in the top layer 12. The degrading tool can be a rotary die-cutting tool or flatbed die-cutting tool. In other embodiments, the degrading tool can be any tool capable of degrading the top layer 12 in any of the manners (e.g., chemical or heat) described herein.

The system 60 further includes a tag applicator 80 configured to adhere a security tag 30 over the degraded portion. In the exemplified embodiment, the tag applicator 80 is an industry-standard high-speed label applicator, though any device for adhering a security tag can be used. The system can include a conveyor belt 55 to transport the package 10 from the degrading tool 70 to the tag applicator 80. In other embodiments, the system can utilize one or more handheld devices. For example, a device can include in a single housing a die-cutting mechanism and a label applicator 80. Alternatively, degrading can be performed by hand by a knife, stamp, or other degrading tool, and the application of a tag can be performed by hand.

Returning to FIG. 7, the tag applicator 80 can include a roll of tags 31 for dispensing on packages 10. The system 60 can also include a sensor device 82 configured to (a) determine the location of the degraded portion; and (b) provide location data (regarding the location of the degraded portion) to the adhering device. When adhering, the tag applicator 80 can locate the security tag 30 based on the location data to ensure proper positioning of the tag 30. In the exemplified embodiment, the sensor 82 is a photoelectric sensor (photo eye), though other types of sensor can be used. The sensor 82 can enable the tag 30 to be centered over or otherwise cover the degraded portion.

While the various example embodiments have been described with respect to specific examples, those skilled in the art will appreciate that there are numerous variations and permutations of the above that may be implemented without departing from the scope of the present invention. Also, it is to be understood that other embodiments may be utilized and structural and functional modifications may be made without departing from the scope of the present invention. Thus, the spirit and scope should be construed broadly as set forth in the appended claims.

What is claimed is:

1. A method of applying a security tag to a product packaging, the method comprising:
cutting a portion of a top layer of a product packaging, the cutting comprising making cuts that form a closed shape, the cutting causing a break in the top layer that exposes a second layer of the product packaging; and
adhering, via an adhesive, a security tag over the cut portion, the adhesive penetrating into the break in the top layer to contact the exposed second layer;
wherein, upon removal of the security tag from the product packaging, a section of the cut portion of the top layer is removed from the product packaging.

2. The method of claim 1 wherein:
the top layer comprises ultraviolet-coated silicon; and
upon removal of the security tag from the product packaging, a section of the second layer is removed from the product packaging.

3. The method of claim 1 wherein the degrading of the portion of the top layer does not cause a break in the exposed second layer.

4. The method of claim 1 wherein:
the cut portion of the top layer comprises a barcode label; and
upon removal of the security tag, a portion of the barcode label is removed rendering the barcode inoperable.

5. A method of applying a security tag to a product packaging, the method comprising:
degrading a portion of a top layer of a product packaging; and
adhering a security tag over the degraded portion.

6. The method of claim 5 wherein, upon removal of the security tag from the product packaging, a portion of the degraded portion of the top layer is removed from the product packaging.

7. The method of claim 5 wherein the degrading of the portion of the top layer causes a break in the top layer that exposes a second layer of the product packaging, and wherein an adhesive penetrates into the break to contact the exposed second layer.

8. The method of claim 7 wherein, upon removal of the security tag, a portion of the second layer is removed from the product packaging.

9. The method of claim 7 wherein the degrading of the portion of the top layer does not cause a break in the exposed second layer.

10. The method of claim 5 wherein the operation of degrading the top layer portion comprises applying a chemical to the top layer.

11. The method of claim 5 wherein the operation of degrading the top layer portion comprises applying heat to the top layer.

12. The method of claim 5 wherein the operation of degrading the top layer portion comprises die cutting the top layer portion.

13. The method of claim 5 wherein the operation of degrading the top layer portion comprises making intersecting cuts.

14. The method of claim 5 wherein the operation of degrading the top layer portion comprises creating an identification pattern of cuts in the top layer portion, the identification pattern being a name, a logo, or an image.

15. The method of claim 5 wherein:
the top layer comprises a barcode label;
the degrading of the top layer portion comprises cutting the barcode label; and
upon removal of the security tag, a portion of the barcode label is removed.

16. The method of claim 15 wherein at least a portion of the security tag is transparent.

17. The method of claim 5 wherein the operation of adhering the security tag over the degraded portion comprises applying an adhesive to the degraded portion and, subsequently, applying the security tag to the adhesive.

18. The method of claim 5 wherein the operation of adhering the security tag over the degraded portion comprises applying an adhesive with a viscosity of 10000-13000 cPs at a temperature of 150-170° C.

19. A system for applying a security tag to a product packaging, the system comprising:
a degrading tool configured to degrade a portion of a top layer of a product packaging; and
a tag applicator configured to adhere a security tag over the degraded portion.

20. The system of claim 19 further comprising a sensor device configured to (a) determine the location of the degraded portion; and (b) provide location data to the adhering device, wherein the tag applicator locates the security tag based on the location data.
